(19) United States
(12) Patent Application Publication
(10) Pub. No.: US 2020/0190264 A1
(43) Pub. Date: Jun. 18, 2020

(54) HYDROPHILIC COPOLYMERS AND MEMBRANES

(71) Applicant: BASF SE, Ludwigshafen am Rhein (DE)

(72) Inventors: Martin WEBER, Ludwigshafen (DE); Kai-Uwe SCHOENING, Basel (CH); Christian MALETZKO, Ludwigshafen (DE)

(73) Assignee: BASF SE, Ludwigshafen am Rhein (DE)

(21) Appl. No.: 16/628,716

(22) PCT Filed: Jul. 12, 2018
(86) PCT No.: PCT/EP2018/069003

§ 371 Date: Jan. 6, 2020

(30) Foreign Application Priority Data
Jul. 20, 2017 (EP) 17182253.9

(51) Int. Cl. C08G 75/23; C08J 9/28

(52) U.S. Cl. CPC C08G 75/23; C08J 2381/06; C08J 2201/04; C08J 9/28

(57) ABSTRACT

The present invention relates to a process for the preparation of a polyarylethersulfone-polyalkylene oxide block copolymer (PPC) by converting a reaction mixture (R_{G}) which comprises, among others, at least one aromatic dihalogen sulfone, at least one dihydroxy component comprising trimethylhydroquinone and at least one polyalkylene oxide. The present invention furthermore relates to a polyarylethersulfone-polyalkylene oxide block copolymer (PPC) obtainable by the inventive process and to its use in a membrane (M) and to a membrane (M) comprising the polyarylethersulfone-polyalkylene oxide block copolymer (PPC). Furthermore, the present invention relates to a method for the preparation of a membrane (M).

The present invention relates to a process for the preparation of a polyarylethersulfone-polyalkylene oxide block copolymer (PPC) by converting a reaction mixture (R_{G}) which comprises, among others, at least one aromatic dihalogen sulfone, at least one dihydroxy component comprising trimethylhydroquinone and at least one polyalkylene oxide. The present invention furthermore relates to a polyarylethersulfone-polyalkylene oxide block copolymer (PPC) obtainable by the inventive process and to its use in a membrane (M) and to a membrane (M) comprising the polyarylethersulfone-polyalkylene oxide block copolymer (PPC). Furthermore, the present invention relates to a method for the preparation of a membrane (M).

Polyarylene ether sulfone polymers are high-performance thermoplastics in that they feature high heat resistance, good mechanical properties and inherent flame retardancy (E. M. Koch, H.-M. Walter, Kunststoffe 80 (1990) 1146; E. Döring, Kunststoffe 80, (1990) 1149, N. Inchaurondo-Nehm, Kunststoffe 98, (2008) 190). Polyarylene ether sulfone polymers are highly biocompatible and so are also used as material for forming dialysis membranes (N. A. Hoenich, K. P. Katapodis, Biomaterials 23 (2002) 3853).

Polyarylene ether sulfone polymers can be formed inter alia either via the hydroxide method, wherein a salt is first formed from the dihydroxy component and the hydroxide, or via the carbonate method.

General information regarding the formation of polyarylene ether sulfone polymers by the hydroxide method is found inter alia in R. N. Johnson et. al., J. Polym. Sci. A-1 5 (1967) 2375, while the carbonate method is described in J. E. McGrath et. al., Polymer 25 (1984) 1827.

Methods of forming polyarylene ether sulfone polymers from aromatic bishalogen compounds and aromatic bisphenols or salts thereof in an aprotic solvent in the presence of one or more alkali metal or ammonium carbonates or bicarbonates are known to a person skilled in the art and are described in EP-A 297 363 and EP-A 135 130, for example.

High-performance thermoplastics such as polyarylene ether sulfone polymers are formed by polycondensation reactions which are typically carried out at a high reaction temperature in polar aprotic solvents, for example DMF (dimethylformamide), DMAc (dimethylacetamide), sulfolane, DMSO (dimethylsulfoxide) and NMP (N-methylpyrrolidone).

Rose et al., Polymer 1996, Vol. 37, No. 9, pp. 1735-1743 describe the preparation of sulfonated methylated polyarylene ether sulfones, using, among others, trimethylhydroquinone and 4-dichlorodiphenylsulfone in the presence of potassium carbonate. The polymerization is carried out in the presence of sulfolane and toluene under nitrogen atmosphere. The described polymerization needs thorough removal of water and high reaction temperatures.

DE 3614753 describes the preparation of polyarylene ether sulfones comprising polyaryleneether ether sulfone units and polyarylene sulfone units. A copolymer comprising 12.5 mol-% of units derived from trimethylhydroquinone based on the total amount of units derived from dihydroxy compounds is disclosed.

Applications of polyarylene ether sulfone polymers in polymer membranes are increasingly important. Membrane materials are classified into two broad groups, polymeric materials and non-polymeric materials. Polymeric membranes have been widely used for gas separation because of their relatively low costs and easy processing into hollow fiber membranes for industrial applications. On the other hand, non-polymeric membranes based on ceramics, nanoparticles, metal organic frameworks, carbon nanotubes, zeolites and others tend to have better thermal and chemical stability and higher selectivity for gas separation. Nevertheless their drawbacks of mechanical brittleness, considerable costs, difficulties in pore size control and formation of defect-free layer may render them to be less commercially attractive.

Furthermore, membranes are divided into dense membranes and porous membranes.

Dense membranes comprise virtually no pores and are in particular used for gas separation. Porous membranes comprise pores having a diameter in the range from 1 to 10000 nm and are mainly used in micro-, ultra- and nanofiltration. In particular, porous membranes are suitable as dialysis membranes and as membranes for water purification.

A further disadvantage for some applications is the low hydrophilicity of polyarylether polymers. To increase the hydrophilicity various methods are described. For example, polyethersulfone-polyethylene oxide block copolymers are known. However, these block copolymers have a significantly lower glass transition temperature than the polyethersulfone homopolymers.

It is therefore an object of the present invention to provide a method for forming polyarylethersulfone-polyalkylene oxide block copolymers (PPC) which do not retain the disadvantages of the prior art or only in diminished form. The method shall be performable with short reaction times. Furthermore, the polyarylethersulfone-polyalkylene oxide block copolymers (PPC) obtainable by the inventive process shall be suitable for use in membranes.

This object is achieved by a process for the preparation of a polyarylethersulfone-polyalkylene oxide block copolymer (PPC) comprising step

I) converting a reaction mixture (R_{G}) comprising as components
(A1) at least one aromatic dihalogen sulfone,
(B1) at least one aromatic dihydroxy component comprising trimethylhydroquinone,
(B2) at least one polyalkylene oxide,
(C) at least one carbonate component,
(D) at least one aprotic polar solvent.

It has surprisingly been found that the polyarylethersulfone-polyalkylene oxide block copolymers (PPC) obtainable by the inventive process have a significantly increased glass transition temperature.

Furthermore, membranes (M) which are prepared from the polyarylethersulfone-polyalkylene oxide block copolymers (PPC) obtainable by the inventive process have a better permeability compared to membranes prepared from polymers having a similar glass transition temperature as the inventive polyarylethersulfone-polyalkylene oxide block copolymers (PPC).

Moreover, the polyarylethersulfone-polyalkylene oxide block copolymers (PPC) obtainable by the inventive process and therefore also membranes (M) made therefrom, have a significantly higher hydrophilicity than other polyarylene ether sulfones and exhibit an improved solvent resistance. At the same time, membranes (M) prepared from the inventive polyarylethersulfone-polyalkylene oxide block copolymer (PPC) exhibit excellent filtration performance.

Membranes (M) prepared from the polyarylethersulfone-polyalkylene block copolymers (PPC) obtainable by the inventive process are in particular suitable as dialysis membranes and as membranes for the treatment of wastewater (produced water).

The present invention will be described in more detail hereinafter.

### Process

In the inventive process the preparation of the polyarylethersulfone-polyalkylene oxide block copolymer (PPC) comprises step I) converting a reaction mixture (R_{G}) comprising the components (A1), (B1), (B2), (C) and (D) described above.

The components (A1), (B1) and (B2) enter into a polycondensation reaction.

Component (D) acts as a solvent and component (C) acts as a base to deprotonate components (B1) and (B2) during the condensation reaction.

Reaction mixture (R_{G}) is understood to mean the mixture that is used in the process according to the present invention for preparing the polyarylethersulfone-polyalkylene oxide block copolymer (PPC). In the present case all details given with respect to the reaction mixture (R_{G}) thus, relate to the mixture that is present prior to the polycondensation. The polycondensation takes place during the process according to the invention in which the reaction mixture (R_{G}) reacts by polycondensation of components (A1), (B1) and (B2) to give the target product, the polyarylethersulfone-polyalkylene oxide block copolymer (PPC). The mixture obtained after the polycondensation which comprises the polyarylethersulfone-polyalkylene oxide block copolymer (PPC) target product is also referred to as product mixture (P_{G}). The product mixture (P_{G}) usually furthermore comprises the at least one aprotic polar solvent (component (D)) and a halide compound. The halide compound is formed during the conversion of the reaction mixture (R_{G}). During the conversion first, component (C) reacts with components (B1) and (B2) to deprotonate components (B1) and (B2). Deprotonated components (B1) and (B2) then react with component (A1) wherein the halide compound is formed. This process is known to the person skilled in the art.

In one embodiment of the present invention in step I) a first polymer (P1) is obtained. This embodiment is described in more detail below. In this embodiment the product mixture (P_{G}) comprises the first polymer (P1). The product mixture (P_{G}) then usually furthermore comprises the at least one aprotic polar solvent (component (D)) and a halide compound. For the halide compound the above described details hold true.

The components of the reaction mixture (R_{G}) are generally reacted concurrently. The individual components may be mixed in an upstream step and subsequently be reacted. It is also possible to feed the individual components into a reactor in which these are mixed and then reacted.

In the process according to the invention, the individual components of the reaction mixture (R_{G}) are generally reacted concurrently in step I). This reaction is preferably conducted in one stage. This means, that the deprotonation of components (B1) and (B2) and also the condensation reaction between components (A1), (B1) and (B2) take place in a single reaction stage without isolation of the intermediate products, for example the deprotonated species of component (B1) or component (B2).

The process according to step I) of the invention is carried out according to the so called “carbonate method”. The process according to the invention is not carried out according to the so called “hydroxide method”. This means, that the process according to the invention is not carried out in two stages with isolation of phenolate anions. Therefore, in a preferred embodiment, the reaction mixture (R_{G}) is essentially free from sodium hydroxide and potassium hydroxide. More preferably, the reaction mixture (R_{G}) is essentially free from alkali metal hydroxides and alkali earth metal hydroxides.

The term “essentially free” in the present case is understood to mean that the reaction mixture (R_{G}) comprises less than 100 ppm, preferably less than 50 ppm of sodium hydroxide and potassium hydroxide, preferably of alkali metal hydroxides and alkali earth metal hydroxides, based on the total weight of the reaction mixture (R_{G}).

It is furthermore preferred that the reaction mixture (R_{G}) does not comprise toluene. It is particularly preferred that the reaction mixture (R_{G}) does not comprise any substance which forms an azeotrope with water.

Another object of the present invention is therefore also a process wherein the reaction mixture (R_{G}) does not comprise any substance which forms an azeotrope with water.

The ratio of component (A1), component (B1) and component (B2) derives in principal from the stoichiometry of the polycondensation reaction which proceeds with theoretical elimination of hydrogen chloride and is established by the person skilled in the art in a known manner.

For example, the reaction mixture (R_{G}) comprises a molar ratio of components (B1) and (B2) to component (A1) from 0.95 to 1.05, especially from 0.97 to 1.04 and most preferably from 0.98 to 1.03.

Another object of the present invention is therefore also a process wherein the molar ratio of components (B1) and (B2) to component (A1) in the reaction mixture (R_{G}) is in the range from 0.95 to 1.05.

Preferably, the conversion in the polycondensation reaction is at least 0.9.

Process step I) for the preparation of the polyarylethersulfone-polyalkylene oxide block copolymer (PPC) is typically carried out under conditions of the so called “carbonate method”. This means that the reaction mixture (R_{G}) is reacted under the conditions of the so called “carbonate method”. The reaction (polycondensation reaction) is generally conducted at temperatures in the range from 80 to 250° C., preferably in the range from 100 to 220° C. The upper limit of the temperature is determined by the boiling point of the at least one aprotic polar solvent (component (D)) at standard pressure (1013.25 mbar). The reaction is generally carried out at standard pressure. The reaction is preferably carried out over a time interval of 2 to 12 h, particularly in the range from 3 to 10 h.

The isolation of the obtained polyarylethersulfone-polyalkylene oxide block copolymer (PPC) obtained in the process according to the present invention in the product mixture (P_{G}) may be carried out for example by precipitation of the product mixture (P_{G}) in water or mixtures of water with other solvents. The precipitated polyarylethersulfone-polyalkylene oxide block copolymer (PPC) can subsequently be extracted with water and then be dried. In one embodiment of the invention, the precipitate can also be taken up in an acidic medium. Suitable acids are for example organic or inorganic acids for example carboxylic acid such as acetic acid, propionic acid, succinic acid or citric acid and mineral acids such as hydrochloric acid, sulfuric acid or phosphoric acid.

In one embodiment of the present invention, in step I) a first polymer (P1) is obtained. The inventive process then preferably additionally comprises step

II) reacting the first polymer (P1) obtained in step I) with an alkyl halide.

Another object of the present invention is therefore also a process, wherein in step I) a first polymer (P1) is obtained and wherein the process additionally comprises step

II) reacting the first polymer (P1) obtained in step I) with an alkyl halide.

To the person skilled in the art it is clear that if step II) is not carried out then the first polymer (P1) corresponds to the polyarylethersulfone-polyalkylene oxide block copolymer (PPC).

The first polymer (P1) usually is the product of the polycondensation reaction of component (A1), component (B1) and component (B2) comprised in the reaction mixture (R_{G}). The first polymer (P1) can be comprised in the above-described product mixture (P_{G}), which is obtained during the conversion of the reaction mixture (R_{G}).

As described above, this product mixture (P_{G}) comprises the first polymer (P1), component (D) and a halide compound. The first polymer (P1) can be comprised in this product mixture (P_{G}) when it is reacted with the alkyl halide.

In one embodiment, the halide compound is separated off from the product mixture (P_{G}) after step I) and before step II) to obtain a second product mixture (P2_{G}). The second product mixture (P2_{G}) then comprises the at least one solvent (component (D)), the first polymer (P1) and, optionally, traces of the halide compound.

“Traces of the halide compound” within the context of the present invention means less than 0.5% by weight, preferably less than 0.1% by weight and most preferably less than 0.01% by weight of the halide compound, based on the total weight of the second product mixture (P2_{G}). The second product mixture (P2_{G}) usually comprises at least 0.0001% by weight, preferably at least 0.0005% by weight and most preferably at least 0.001% by weight of the halide compound, based on the total weight of the second product mixture (P2_{G}).

The separation of the halide compound from the product mixture (P_{G}) can be carried out by any method known to the skilled person, for example via filtration or centrifugation.

The first polymer (P1) usually comprises terminal hydroxy groups. In step II) these terminal hydroxy groups are further reacted with the alkyl halide to obtain the polyarylethersulfone-polyalkylene oxide block copolymer (PPC). Preferred alkyl halides are in particular alkyl chlorides having linear or branched alkyl groups having from 1 to 10 carbon atoms, in particular primary alkyl chlorides, particularly preferably methyl halides, in particular methyl chloride.

The reaction according to step II) is preferably carried out at a temperature in the range from 90° C. to 160° C., in particular in the range from 100° C. to 150° C. The time required can vary over a wide range of times and is usually at least 5 minutes, in particular at least 15 minutes. It is preferable that the time required for the reaction according to step II) is from 15 minutes to 8 hours, in particular from 30 minutes to 4 hours.

Various methods can be used for the addition of the alkyl halide. It is moreover possible to add a stoichiometric amount or an excess of the alkyl halide, and the excess can be by way of example by up to 5-fold. In one preferred embodiment the alkyl halide is added continuously, in particular via continuous introduction in the form of a gas stream.

In step II) usually a polymer solution (PL) is obtained which comprises the polyarylethersulfone-polyalkylene oxide block copolymer (PPC) and component (D). If in step II) the product mixture (P_{G}) from step I) was used, then the polymer solution (PL) typically furthermore comprises the halide compound. It is possible to filter the polymer solution (PL) after step II). The halide compound can thereby be removed.

The present invention therefore also provides a process wherein in step II) a polymer solution (PL) is obtained and wherein the process furthermore comprises step

III) filtration of the polymer solution (PL) obtained in step II).

The isolation of the obtained polyarylethersulfone-polyalkylene oxide block copolymer (PPC) obtained in the step II) according to the present invention in the polymer solution (PL) may be carried out as the isolation of the polyarylethersulfone-polyalkylene oxide block copolymer (PPC) obtained in the product mixture (P_{G}). For example, the isolation may be carried out by precipitation of the polymer solution (PL) in water or mixtures of water with other solvents. The precipitated polyarylethersulfone-polyalkylene oxide block copolymer (PPC) can subsequently be extracted with water and then be dried. In one embodiment of the invention, the precipitate can also be taken up in an acidic medium. Suitable acids are for example organic or inorganic acids for example carboxylic acid such as acetic acid, propionic acid, succinic acid or citric acid and mineral acids such as hydrochloric acid, sulfuric acid or phosphoric acid.

### Component (A1)

The reaction mixture (R_{G}) comprises at least one aromatic dihalogen sulfone as component (A1). The term “at least one aromatic dihalogen sulfone”, in the present case, is understood to mean exactly one aromatic dihalogen sulfone and also mixtures of two or more aromatic dihalogen sulfones. The at least one aromatic dihalogen sulfone (component (A1)) is preferably at least one dihalodiphenyl sulfone.

The present invention therefore also relates to a method in which the reaction mixture (R_{G}) comprises at least one dihalodiphenyl sulfone as component (A1).

The component (A1) is preferably used as a monomer. This means that the reaction mixture (R_{G}) comprises component (A1) as a monomer and not as a prepolymer.

The reaction mixture (R_{G}) comprises preferably at least 50% by weight of a dihalodiphenyl sulfone as component (A1), based on the total weight of component (A1) in the reaction mixture (R_{G}).

Preferred dihalodiphenyl sulfones are the 4,4′-dihalodiphenyl sulfones. Particular preference is given to 4,4′-dichlorodiphenyl sulfone, 4,4′-difluorodiphenyl sulfone and/or 4,4′-dibromodiphenyl sulfone as component (A1). 4,4′-Dichlorodiphenyl sulfone and 4,4′-difluorodiphenyl sulfone are particularly preferred, while 4,4′-dichlorodiphenyl sulfone is most preferred.

An object of the present invention is therefore also a process wherein component (A1) is selected from the group consisting of 4,4′-dichlorodiphenyl sulfone and 4,4′-difluorodiphenyl sulfone.

The present invention therefore also relates to a method wherein component (A1) comprises at least 50% by weight of at least one aromatic dihalogen sulfone selected from the group consisting of 4,4′-dichlorodiphenyl sulfone and 4,4′-difluorodiphenyl sulfone, based on the total weight of component (A1) in the reaction mixture (R_{G}).

In a particularly preferred embodiment, component (A1) comprises at least 80% by weight, preferably at least 90% by weight, more preferably at least 98% by weight, of an aromatic dihalogen sulfone selected from the group consisting of 4,4′-dichlorodiphenyl sulfone and 4,4′-difluorodiphenyl sulfone, based on the total weight of component (A1) in the reaction mixture (R_{G}).

In a further particularly preferred embodiment, component (A1) consists essentially of at least one aromatic dihalogen sulfone selected from the group consisting of 4,4′-dichlorodiphenyl sulfone and 4,4′-difluorodiphenyl sulfone. “Consisting essentially of”, in the present case, is understood to mean that component (A1) comprises more than 99% by weight, preferably more than 99.5% by weight, particularly preferably more than 99.9% by weight, of at least one aromatic dihalogen sulfone compound selected from the group consisting of 4,4′-dichlorodiphenyl sulfone and 4,4′-difluorodiphenyl sulfone, based in each case on the total weight of component (A1) in the reaction mixture (R_{G}). In these embodiments, 4,4′-dichlorodiphenyl sulfone is particularly preferred as component (A1).

In a further particularly preferred embodiment, component (A1) consists of 4,4′-dichlorodiphenyl sulfone.

### Component (B1)

The reaction mixture (R_{G}) comprises at least one dihydroxy component comprising trimethylhydroquinone as component (B1). The term “at least one dihydroxy component”, in the present case, is understood to mean exactly one dihydroxy component and also mixtures of two or more dihydroxy components. Preferably, component (B1) is precisely one dihydroxy component or a mixture of precisely two dihydroxy components. Most preferred component (B1) is precisely one dihydroxy component.

The dihydroxy components used are typically components having two phenolic hydroxyl groups. Since the reaction mixture (R_{G}) comprises at least one carbonate component, the hydroxyl groups of component (B1) in the reaction mixture (R_{G}) may be present partially in deprotonated form.

Component (B1) is preferably used as a monomer. This means that the reaction mixture (R_{G}) comprises component (B1) preferably as monomer and not as prepolymer.

Component (B1) comprises usually at least 5 mol-%, preferably at least 20 mol-% and more preferably at least 50 mol-% of trimethylhydroquinone based on the total amount of the at least one dihydroxy component. Preferably, component (B1) comprises from 50 to 100 mol-%, more preferably from 80 to 100 mol-% and most preferably from 95 to 100 mol-% of trimethylhydroquinone based on the total amount of the at least one dihydroxy component in the reaction mixture (R_{G}).

Another object of the present invention is therefore also a process wherein component (B1) comprises at least 50 mol-% of trimethylhydroquinone based on the total amount of component (B1).

In a preferred embodiment, component (B1) consists essentially of trimethylhydroquinone.

“Consisting essentially of” in the present case is understood to mean that component (B1) comprises more than 99 mol-%, preferably more than 99.5 mol-%, particular preferably more than 99.9 mol-% of trimethylhydroquinone based in each case on the total amount of component (B1) in the reaction mixture (R_{G}).

In a further preferred embodiment, component (B1) consists of trimethylhydroquinone.

Trimethylhydroquinone is also known as 2,3,5-trimethylhydroquinone. It has the CAS-number 700-13-0. Methods for its preparation are known to the skilled person.

Suitable further dihydroxy components that can be comprised as component (B1) are known to the skilled person and are for example selected from the group consisting of 4,4′-dihydroxybiphenyl and 4,4′-dihydroxydiphenyl sulfone. In principal, other aromatic dihydroxy compounds can also be comprised such as bisphenol A (IUPAC-name: 4,4′-(propane-2,2-diyl)diphenol).

### Component (B2)

The reaction mixture (R_{G}) comprises at least one polyalkylene oxide as component (B2).

“At least one polyalkylene oxide” is understood to mean according to the invention, either exactly one polyalkylene oxide or mixtures of two or more polyalkylene oxides.

Suitable polyalkylene oxides according to the invention are known to the skilled person. Preferably, the at least one polyalkylene oxide is obtainable by polymerization of ethylene oxide, 1,2-propylene oxide, 1,2-butylene oxide, 2,3-butylen oxide, 1,2-pentene oxide, 2,3-pentene oxide, tetrahydrofuran or mixtures of two or more of these monomers. More preferably, the at least one polyalkylene oxide is obtainable by polymerization of ethylene oxide, 1,2-propylene oxide, 1,2-butylene oxide or mixtures of two or more of these monomers.

Therefore, in one preferred embodiment, the at least one polyalkylene oxide is preferably selected from the group consisting of polyethylene glycol, polypropylene glycol, poly(butylene oxide) and a copolymer of polyethylene glycol and polypropylene glycol.

Polyethylene glycol is also known as poly(ethylene oxide) (PEO); polypropylene glycol is also known as poly(propylene oxide) (PPO).

A preferred copolymer of polyethylene glycol and polypropylene glycol is a poly(ethylene oxide)-poly(propylene oxide)-poly(ethylene oxide) blockcopolymer (PEO-PPO-PEO-copolymer). These copolymers are for example obtainable under the trade name Pluronic® by BASF SE.

Particularly preferred polyalkylene oxides are those having two hydroxyl groups. Such polyalkylene oxides are also referred to as polyether diols. Suitable polyalkylene oxides generally comprise 1 to 1000 alkylene oxide units. Preference is given to polyalkylene oxides comprising 2 to 500, particularly preferably 3 to 150, especially preferably to 100 and most preferably 10 to 80 alkylene oxide units.

The polyalkylene oxides which are comprised in the reaction mixture (R_{G}) generally have a number average molecular weight (Mₙ) of at least 66 g/mol, preference is given to polyalkylene oxides having a number average molecular weight (Mₙ) in the range from 66 to 104 000 g/mol, particularly preferably in the range from 400 to 40 000 g/mol and most preferably in the range from 600 to 20 000 g/mol.

Since at least one carbonate component (component (C)) is comprised in the reaction mixture (R_{G}) the at least one polyalkylene oxide in the reaction mixture (R_{G}) may be present at least partially in deprotonated form.

The molecular weights of the polyalkylene oxides are determined by measuring the OH-number.

The OH-number of the polyalkylene oxides used is determined by means of potentiometric titration. The OH-groups are initially esterified by means of an acylation mixture of acetic anhydride and pyridine. The excess of acetic anhydride is determined by titration with 1 molar KOH. From the consumption of KOH, the amount of acidic anhydride and the initial sample weight the OH-number can then be calculated.

The at least one polyalkylene oxide which is present in the reaction mixture (R_{G}) is preferably added to the reaction mixture (R_{G}) as such. This means that the polyalkylene oxide is preferably not used in activated form.

“Activated form” is understood to mean hydroxyl groups which have been converted by a chemical reaction into a leaving group such as methylate groups.

Component (B2) for example comprises at least 50% by weight of a polyalkylene oxide which is obtainable by polymerization of ethylene oxide, 1,2-propylene oxide, 1,2-butylene oxide, 2,3-butylene oxide, 1,2-pentene oxide, 2,3-pentene oxide, tetrahydrofuran or mixture of two or more of these monomers based on the total weight of component (B2).

Another object of the present invention is therefore also a process wherein component (B2) comprises at least 50% by weight of a polyalkylene oxide which is obtainable by polymerization of ethylene oxide, 1,2-propylene oxide, 1,2-butylene oxide, 2,3-butylene oxide, 1,2-pentene oxide, 2,3-pentene oxide, tetrahydrofuran, or mixtures of two or more of these monomers, based on the total weight of component (B2).

It is particularly preferred that component (B2) comprises at least 80% by weight, preferably at least 90% by weight, more preferably at least 98% by weight of a polyalkylene oxide which is obtainable by polymerization of ethylene oxide, 1,2-propylene oxide, 1,2-butylene oxide, 2,3-butylene oxide, 1,2-pentene oxide, 2,3-pentene oxide, tetrahydrofuran or mixture of two or more of these monomers based on the total weight of component (B2) in the reaction mixture (R_{G}).

In a further particularly preferred embodiment component (B2) consists essentially of a polyalkylene oxide which is obtainable by polymerization of ethylene oxide, 1,2-propylene oxide, 1,2-butylene oxide, 2,3-butylene oxide, 1,2-pentene oxide, 2,3-pentene oxide, tetrahydrofuran or mixture of two or more of these monomers.

“Consisting essentially of” in the present case is understood to mean that component (B2) comprises more than 99% by weight, preferably more than 99.5% by weight, particular preferably more than 99.9% by weight of a polyalkylene oxide which is obtainable by polymerization of ethylene oxide, 1,2-propylene oxide, 1,2-butylene oxide, 2,3-butylene oxide, 1,2-pentene oxide, 2,3-pentene oxide, tetrahydrofuran or mixture of two or more of these monomers based on the total weight of component (B2) in the reaction mixture (R_{G}).

### Component (C)

The reaction mixture (R_{G}) comprises at least one carbonate component as component (C). The term “at least one carbonate component” in the present case, is understood to mean exactly one carbonate component and also mixtures of two or more carbonate components. The at least one carbonate component is preferably at least one metal carbonate. The metal carbonate is preferably anhydrous.

Preference is given to alkali metal carbonates and/or alkaline earth metal carbonates as metal carbonates. At least one metal carbonate selected from the group consisting of sodium carbonate, potassium carbonate and calcium carbonate is particularly preferred as metal carbonate. Potassium carbonate is most preferred.

For example, component (C) comprises at least 50% by weight, more preferred at least 70% by weight and most preferred at least 90% by weight of potassium carbonate based on the total weight of the at least one carbonate component in the reaction mixture (R_{G}).

Another object of the present invention is therefore also a process wherein component (C) comprises at least 50% by weight of potassium carbonate, based on the total weight of component (C).

In a preferred embodiment component (C) consists essentially of potassium carbonate.

“Consisting essentially of” in the present case is understood to mean that component (C) comprises more than 99% by weight, preferably more than 99.5% by weight, particular preferably more than 99.9% by weight of potassium carbonate based in each case on the total weight of component (C) in the reaction mixture (R_{G}).

In a particularly preferred embodiment component (C) consists of potassium carbonate.

Potassium carbonate having a volume weighted average particle size of less than 200 μm is particularly preferred as potassium carbonate. The volume weighted average particle size of the potassium carbonate is determined in a suspension of potassium carbonate in N-methylpyrrolidone using a particle size analyser.

In a preferred embodiment, the reaction mixture (R_{G}) does not comprise any alkali metal hydroxides or alkaline earth metal hydroxides.

### Component (D)

The reaction mixture (R_{G}) comprises at least one aprotic polar solvent as component (D). “At least one aprotic polar solvent”, according to the invention, is understood to mean exactly one aprotic polar solvent and also mixtures of two or more aprotic polar solvents.

Suitable aprotic polar solvents are, for example, selected from the group consisting of anisole, dimethylformamide, dimethylsulfoxide, N-methylpyrrolidone, N-ethylpyrrolidone and N-dimethylacetamide.

Preferably, component (D) is selected from the group consisting of N-methylpyrrolidone, N-dimethylacetamide, dimethylsulfoxide and dimethylformamide. N-methylpyrrolidone is particularly preferred as component (D).

Another object of the present invention is therefore also a process wherein component (D) is selected from the group consisting of N-methylpyrrolidone, N-dimethylacetamide, dimethylsulfoxide and dimethylformamide.

It is preferred that component (D) does not comprise sulfolane. It is furthermore preferred that the reaction mixture (R_{G}) does not comprise sulfolane.

It is preferred that component (D) comprises at least 50% by weight of at least one solvent selected from the group consisting of N-methylpyrrolidone, N-dimethylacetamide, dimethylsulfoxide and dimethylformamide based on the total weight of component (D) in the reaction mixture (R_{G}). N-methylpyrrolidone is particularly preferred as component (D).

In a further preferred embodiment, component (D) consists essentially of N-methylpyrrolidone.

“Consist essentially of”, in the present case, is understood to mean that component (D) comprises more than 98% by weight, particularly preferably more than 99% by weight, more preferably more than 99.5% by weight, of at least one aprotic polar solvent selected from the group consisting of N-methylpyrrolidone, N-dimethylacetamide, dimethylsulfoxide and dimethylformamide with preference given to N-methylpyrrolidone.

In a preferred embodiment, component (D) consists of N-methylpyrrolidone. N-methylpyrrolidone is also referred to as NMP or N-methyl-2-pyrrolidone.

Polyarylethersulfone-polyalkylene oxide block copolymer (PPC)

The polyarylethersulfone-polyalkylene oxide block copolymer (PPC) obtained by the inventive process comprises units that are derived from component (A1), units that are derived from component (B1) and units that are derived from component (B2). In a preferred embodiment, the polyarylethersulfone-polyalkylene oxide block copolymer (PPC) consists of units that are derived from component (A1), units that are derived from component (B1) and units that are derived from component (B2). To the person skilled in the art it is clear, that if in one embodiment of the present invention step II) is carried out then at least some of the polyarylethersulfone-polyalkylene oxide block copolymer (PPC) endgroups are not derived from components (A1), (B1) and (B2).

It is preferred that the polyarylethersulfone-polyalkylene oxide block copolymer (PPC) comprises units of formula (Ia) and/or formula (Ib).

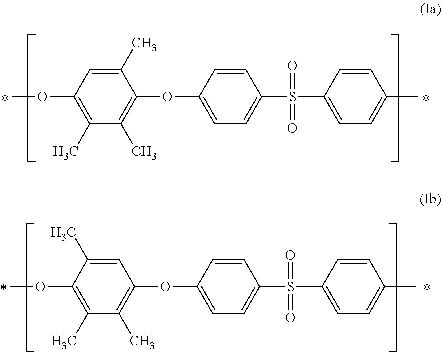

In formulae (la) and (Ib) * indicates a bond. This bond can, for example, be a link to another unit of formula (Ia) or (Ib), a link to a unit derived from component (B2) or a link to an alkyl or an alkoxy endgroup as described below.

To the person skilled in the art it is clear that formulae (la) and (Ib) encompass possible isomers of the formulae as well.

In the inventive process high incorporation rates of the at least one polyalkylene oxide (component (B2)) are achieved. Incorporation rates with respect to the at least one polyalkylene oxide in the present case are understood to mean the amount of the at least one polyalkylene oxide which is present in covalently bound form in the polyarylethersulfone-polyalkylene oxide block copolymer (PPC) following the polycondensation based on the amount of the at least one polyalkylene oxide (component (B2)) originally present in the reaction mixture (R_{G}). The method according to the invention achieves incorporation rates of 85%, preferably of 90%.

The present invention therefore also relates to a process, wherein at least 85% by weight, preferably at least 90% by weight of component (B2) present in the reaction mixture (R_{G}) are incorporated into the polyarylethersulfone-polyalkylene oxide block copolymer (PPC).

Polyarylethersulfone-polyalkylene oxide block copolymers (PPC) obtainable by the inventive process exhibit a low polydispersity (Q) and high glass transition temperatures (T_{g}). The polyarylethersulfone-polyalkylene oxide block copolymers (PPC) moreover have very low amounts of impurities, for example, azeotroping agents such as toluene or chlorobenzene.

The polydispersity (Q) is defined as the ratio (quotient) of the weight average molecular weight (M_{w}) and the number average molecular weight (Mₐ). In a preferred embodiment the polydispersity (Q) of the polyarylethersulfone-polyalkylene oxide block copolymers (PPC) is in the range of 2.0 to 4.5, preferably in the range of 2.0 to 5.

The polyarylethersulfone-polyalkylene oxide block copolymer (PPC) obtainable by the inventive process preferably has a weight average molecular weight (M_{w}) in the range from 15 000 to 180 000 g/mol, more preferably in the range from 20 000 to 150 000 g/mol and particularly preferably in the range from 25 000 to 125 000 g/mol, determined by GPC (Gel Permeation Chromatography). GPC-Analysis is done using Dimethylacetamide with 0.5 wt. % LiBr as solvent, the polymer concentration is 4 mg/mL. The system is calibrated with PMMA-standards. As columns three different polyestercopolymers based units are used. After dissolving the material, the obtained solution is filtered using a filter with 0.2 μm pore size, then 100 μL solution are injected into the system, the elution rate is set at 1 mL/min.

The polyarylethersulfone-polyalkylene oxide block copolymer (PPC) obtainable by the inventive process, furthermore, has preferably a number average molecular weight (Mₙ) in the range from 5 000 to 75 000 g/mol, more preferably in the range from 6 000 to 60 000 g/mol and particularly preferably in the range from 7 500 to 50 000 g/mol, determined by GPC (Gel Permeation Chromatography). GPC-analysis is performed as described above.

The glass transition temperature (T_{g}) of the polyarylethersulfone-polyalkylene oxide block copolymer (PPC) is typically in the range from 130 to 260° C., preferably in the range from 135 to 230° C. and particularly preferably in the range from 150 to 200° C. determined via differential scanning calorimetry (DSC) with a heating rate of 10 K/min in the second heating cycle.

The viscosity number (V.N.) of the polyarylethersulfone-polyalkylene oxide block copolymer (PPC) is determined as a 1% solution in N-methylpyrrolidone at 25° C. The viscosity number (V.N.) is typically in the range from 45 to 120 ml/g, preferably in the range from 50 to 100 ml/g and most preferably in the range from 55 to 90 ml/g.

If the above-described step II) is carried out in the inventive process for the preparation of a polyarylethersulfone-polyalkylene oxide block copolymer (PPC), then the obtained polyarylethersulfone-polyalkylene oxide block copolymer (PPC) usually comprises alkoxy endgroups. The alkoxy endgroups result from the reaction of the alkyl halide with at least some of the hydroxy endgroups of the first polymer (P1) obtained in this embodiment of the invention in step I). The polyarylethersulfone-polyalkylene oxide block copolymer (PPC) can furthermore comprise halogen-endgroups which are derived from component (A1) and/or hydroxy end groups derived from component (B1) and/or component (B2). This is known to the person skilled in the art.

An “alkoxy endgroup” within the context of the present invention is an alkyl group bonded to oxygen. The alkyl group is particularly a linear or branched alkyl group having from 1 to 10 carbon atoms, in particular a methyl group. Therefore, the alkoxy group is preferably a methoxy (MeO) group.

Another object of the present invention is therefore also a polyarylethersulfone-polyalkylene oxide block copolymer (PPC) obtainable by the inventive process.

It is preferred that the polyarylethersulfone-polyalkylene oxide block copolymer (PPC) comprises an average 1 to 3 polyalkylene oxide blocks and 1 to 4 polyarylether sulfone blocks.

### Membrane (M)

The polyarylethersulfone-polyalkylene oxide block copolymer (PPC) obtainable by the inventive process can be used in a membrane (M).

Another object of the present invention is therefore also the use of the polyarylethersulfone-polyalkylene oxide block copolymer (PPC) obtainable by the inventive process in a membrane (M).

A further object of the present invention is a membrane (M) which comprises the polyarylethersulfone-polyalkylene oxide block copolymer (PPC) which is obtainable by the above described process.

Therefore, another object of the present invention is also a membrane (M) comprising a polyarylethersulfone-polyalkylene oxide block copolymer (PPC) obtainable by the inventive process.

The membrane (M) comprises preferably at least 50% by weight of the polyarylethersulfone-polyalkylene oxide block copolymer (PPC), more preferably at least 70% by weight and most preferably at least 90% by weight of the polyarylethersulfone-polyalkylene oxide block copolymer (PPC) based on the total weight of the membrane (M).

In a further preferred embodiment, the membrane (M) consists essentially of the polyarylethersulfone-polyalkylene oxide block copolymer (PPC).

“Consisting essentially of” means that the membrane (M) comprises more than 93% by weight, preferably more than 95% by weight and most preferably more than 97% by weight of the polyarylethersulfone-polyalkylene oxide block copolymer (PPC) based on the total weight of the membrane (M).

During the formation of the membrane (M) the polyarylethersulfone-polyalkylene oxide block copolymer (PPC) is separated from the at least one solvent. Therefore, the obtained membrane (M) is essentially free from the at least one solvent.

“Essentially free” within the context of the present invention means that the membrane (M) comprises at most 7% by weight, preferably at most 5% by weight and particularly preferably at most 3% by weight of the at least one solvent based on the total weight of the membrane (M). The membrane (M) comprises at least 0.0001% by weight, preferably at least 0.001% by weight and particularly preferably at least 0.01% by weight of the at least one solvent based on the total weight of the membrane (M).

To the person skilled in the art it is clear that if in one embodiment of the present invention additives for the membrane preparation are used in the preparation of the membrane (M) then the membrane (M) usually furthermore comprises the additives for the membrane preparation. For example, the membrane (M) then comprises in the range from 0.1 to 10% by weight, preferably in the range from 0.15 to 7.5% by weight, and most preferably in the range from 0.2 to 5% by weight of the additive for the membrane preparation, based on the total weight of the membrane (M).

During the preparation of the membrane (M) the solvent exchange usually leads to an asymmetric membrane structure. This is known to the skilled person. Therefore, the membrane (M) is preferably asymmetric. In an asymmetric membrane the pore size increases from the top layer, which is used for separation, to the bottom of the membrane.

Another object of the present invention is therefore a membrane (M) wherein the membrane (M) is asymmetric.

In one embodiment of the present invention the membrane (M) is porous.

Therefore, another object of the present invention is a membrane (M) wherein the membrane (M) is a porous membrane.

If the membrane (M) is a porous membrane then the membrane (M) typically comprises pores. The pores usually have a diameter in the range from 1 nm to 10000 nm, preferably in the range from 2 to 500 nm and particularly preferably in the range from 5 to 250 nm determined via filtration experiments using a solution containing different PEG's (polyethylene glycols) covering a molecular weight from 300 to 1000000 g/mol. By comparing the GPC-traces of the feed and the filtrate, the retention of the membrane (M) for each molecular weight can be determined. The molecular weight, where the membrane (M) shows a 90% retention is considered as the molecular weight cutoff (MWCO) for this membrane (M) under the given conditions. Using the known correlation between the Stoke diameters of PEG and their molecular weights, the mean pore size of a membrane can be determined. Details about this method are given in the literature (Chung, J. Membr. Sci. 531 (2017) 27-37).

A porous membrane is typically obtained if the membrane (M) is prepared via a phase inversion process.

In another embodiment of the present invention the membrane (M) is a dense membrane.

Therefore, another object of the present invention is also a membrane (M) wherein the membrane (M) is a dense membrane.

Another object of the present invention is also a membrane (M) wherein the membrane (M) is a porous membrane or a dense membrane.

If the membrane (M) is a dense membrane then the membrane (M) typically comprises virtually no pores.

A dense membrane is typically obtained by a solution casting process in which a solvent comprised in the casted solution is evaporated. Usually the solution (S) is casted on a support, which might be another polymer like polysulfone or celluloseacetate. On top of the membrane (M) sometimes a layer of polydimethylsiloxane is applied.

The membrane (M) can have any thickness. For example, the thickness of the membrane (M) is in the range from 2 to 1000 μm, preferably in the range from 3 to 300 μm and most preferably in the range from 5 to 150 μm.

The inventive membrane (M) can be used in any processes known to the skilled person in which membranes are used.

In particular, if the membrane (M) is a dense membrane, it is particular suitable for the gas separation.

Another object of the present invention is therefore also the use of the membrane (M) for gas separation.

In another embodiment, the membrane (M) is used for nanofiltration, ultrafiltration and/or microfiltration. The membrane (M) is particular suitable for nanofiltration, microfiltration and/or ultrafiltration if the membrane (M) is a porous membrane.

Typical nanofiltration, ultrafiltration and microfiltration processes are known to the skilled person. For example, the membrane (M) can be used in a dialysis process as dialysis membrane.

The polyarylethersulfone-polyalkylene oxide block copolymer (PPC) obtainable by the inventive process is particular suitable for dialysis membrane due to its good biocompatibility.

### Membrane Preparation

A membrane (M) can be prepared from the polyarylethersulfone-polyalkylene oxide block copolymer (PPC) according to the present invention by any method known to the skilled person.

Preferably, a membrane (M) comprising the polyarylethersulfone-polyalkylene oxide block copolymer (PPC) obtainable by the inventive process is prepared by a method comprising the steps
i) providing a solution (S) which comprises the polyarylethersulfone-polyalkylene oxide block copolymer (PPC) and at least one solvent,
ii) separating the at least one solvent from the solution (S) to obtain the membrane (M).

Another object of the present invention is therefore a method for the preparation of an inventive membrane (M), wherein the method comprises the steps
i) providing a solution (S) which comprises the polyarylethersulfone-polyalkylene oxide block copolymer (PPC) and at least one solvent,
ii) separating the at least one solvent from the solution (S) to obtain the membrane (M).

### Step i)

In step i) a solution (S) is provided which comprises the polyarylethersulfone-polyalkylene oxide block copolymer (PPC) and at least one solvent.

“At least one solvent” within the context of the present invention means precisely one solvent and also a mixture of two or more solvents.

The solution (S) can be provided in step i) by any method known to the skilled person. For example, the solution (S) can be provided in step i) in customary vessels which may comprise a stirring device and preferably a temperature control device. Preferably, the solution (S) is provided by dissolving the polyarylethersulfone-polyalkylene oxide block copolymer (PPC) in the at least one solvent.

The dissolution of the polyarylethersulfone-polyalkylene oxide block copolymer (PPC) in the at least one solvent to provide the solution (S) is preferably effected under agitation.

Step i) is preferably carried out at elevated temperatures, especially in the range from to 120° C., more preferably in the range from 40 to 100° C. A person skilled in the art will choose the temperature in accordance with the at least one solvent.

The solution (S) preferably comprises the polyarylethersulfone-polyalkylene oxide block copolymer (PPC) completely dissolved in the at least one solvent. This means that the solution (S) preferably comprises no solid particles of the polyarylethersulfone-polyalkylene oxide block copolymer (PPC). Therefore, the polyarylethersulfone-polyalkylene oxide block copolymer (PPC) preferably cannot be separated from the at least one solvent by filtration.

The solution (S) preferably comprises from 0.001 to 50% by weight of the polyarylethersulfone-polyalkylene oxide block copolymer (PPC) based on the total weight of the solution (S). More preferably, the solution (S) in step i) comprises from 0.1 to 30% by weight of the polyarylethersulfone-polyalkylene oxide block copolymer (PPC) and most preferably the solution (S) comprises from 0.5 to 25% by weight of the polyarylethersulfone-polyalkylene oxide block copolymer (PPC) based on the total weight of the solution (S).

Another object of the present invention is therefore also a method for the preparation of a membrane (M) wherein the solution (S) in step i) comprises from 0.1 to 30% by weight of the polyarylethersulfone-polyalkylene oxide block copolymer (PPC), based on the total weight of the solution (S).

As the at least one solvent, any solvent known to the skilled person for the polyarylethersulfone-polyalkylene oxide block copolymer (PPC) is suitable. Preferably, the at least one solvent is soluble in water. Therefore, the at least one solvent is preferably selected from the group consisting of N-methylpyrrolidone, dimethylacetamide, dimethylsulfoxide, dimethyllactamide, dimethylformamide and sulfolane. N-methylpyrrolidone and dimethyllactamide are particularly preferred. Dimethyllactamide is most preferred as the at least one solvent.

Another object of the present invention is therefore also a method for the preparation of a membrane (M) wherein the at least one solvent is selected from the group consisting of N-methylpyrrolidone, dimethylacetamide, dimethyl sulfoxide, dimethylformamide, dimethyllactamide and sulfolane.

The solution (S) preferably comprises in the range from 50 to 99.999% by weight of the at least one solvent, more preferably in the range from 70 to 99.9% by weight and most preferably in the range from 75 to 99.5% by weight of the at least one solvent based on the total weight of the solution (S).

The solution (S) provided in step i) can furthermore comprise additives for the membrane preparation.

Suitable additives for the membrane preparation are known to the skilled person and are, for example, polyvinylpyrrolidone (PVP), polyethylene oxide (PEO), polyethylene oxide-polypropylene oxide copolymer (PEO-PPO) and poly(tetrahydrofuran) (poly-THF). Polyvinylpyrrolidone (PVP) and polyethylene oxide (PEO) are particularly preferred as additives for the membrane preparation.

The additives for membrane preparation can, for example, be comprised in the solution (S) in an amount of from 0.01 to 20% by weight, preferably in the range from 0.1 to 15% by weight and more preferably in the range from 1 to 10% by weight based on the total weight of the solution (S).

To the person skilled in the art it is clear that the percentages by weight of the polyarylethersulfone-polyalkylene oxide block copolymer (PPC), the at least one solvent and the optionally comprised additive for membrane preparation comprised in the solution (S) typically add up to 100% by weight.

The duration of step i) may vary between wide limits. The duration of step i) is preferably in the range from 10 min to 48 h (hours), especially in the range from 10 min to 24 h and more preferably in the range from 15 min to 12 h. A person skilled in the art will choose the duration of step i) so as to obtain a homogeneous solution of the polyarylethersulfone-polyalkylene oxide block copolymer (PPC) in the at least one solvent.

For the polyarylethersulfone-polyalkylene oxide block copolymer (PPC) comprised in the solution (S) the embodiments and preferences given for the polyarylethersulfone-polyalkylene oxide block copolymer (PPC) obtainable in the inventive process hold true.

### Step ii)

In step ii) the at least one solvent is separated from the solution (S) to obtain the membrane (M). It is possible to filter the solution (S) provided in step i) before the at least one solvent is separated from the solution (S) in step ii) to obtain a filtered solution (fS). The following embodiments and preferences for separating the at least one solvent from the solution (S) applies equally for separating the at least one solvent from the filtered solution (fS) which is used in this embodiment of the invention.

Moreover, it is possible to degas the solution (S) in step i) before the at least one solvent is separated from the solution (S) in step ii) to obtain a degassed solution (dS). This embodiment is preferred. The following embodiments and preferences for separating the at least one solvent from the solution (S) apply equally for separating the at least one solvent from the degassed solution (dS) which is used in this embodiment of the invention.

The degassing of the solution (S) in step i) can be carried out by any method known to the skilled person, for example via vacuum or by allowing the solution (S) to rest.

The separation of the at least one solvent from the solution (S) can be performed by any method known to the skilled person which is suitable to separate solvents from polymers.

Preferably, the separation of the at least one solvent from the solution (S) is carried out via a phase inversion process.

Another object of the present invention is therefore also a method for the preparation of a membrane (M), wherein the separation of the at least one solvent in step ii) is carried out via a phase inversion process.

If the separation of the at least one solvent is carried out via a phase inversion process, the obtained membrane (M) is typically a porous membrane.

A phase inversion process within the context of the present invention means a process wherein the dissolved polyarylethersulfone-polyalkylene oxide block copolymer (PPC) is transformed into a solid phase. Therefore, a phase inversion process can also be denoted as precipitation process. According to step ii) the transformation is performed by separation of the at least one solvent from the polyarylethersulfone-polyalkylene oxide block copolymer (PPC). The person skilled in the art knows suitable phase inversion processes.

The phase inversion process can, for example, be performed by cooling down the solution (S). During this cooling down, the polyarylethersulfone-polyalkylene oxide block copolymer (PPC) comprised in this solution (S) precipitates. Another possibility to perform the phase inversion process is to bring the solution (S) in contact with a gaseous liquid that is a non-solvent for the polyarylethersulfone-polyalkylene oxide block copolymer (PPC). The polyarylethersulfone-polyalkylene oxide block copolymer (PPC) will then as well precipitate. Suitable gaseous liquids that are non-solvents for the polyarylethersulfone-polyalkylene oxide block copolymer (PPC) are for example protic polar solvents described hereinafter in their gaseous state. Another phase inversion process which is preferred within the context of the present invention is the phase inversion by immersing the solution (S) into at least one protic polar solvent.

Therefore, in one embodiment of the present invention, in step ii) the at least one solvent comprised in the solution (S) is separated from the polyarylethersulfone-polyalkylene oxide block copolymer (PPC) comprised in the solution (S) by immersing the solution (S) into at least one protic polar solvent.

This means that the membrane (M) is formed by immersing the solution (S) into at least one protic polar solvent.

Suitable at least one protic polar solvents are known to the skilled person. The at least one protic polar solvent is preferably a non-solvent for the polyarylethersulfone-polyalkylene oxide block copolymer (PPC).

Preferred at least one protic polar solvents are water, methanol, ethanol, n-propanol, iso-propanol, glycerol, ethyleneglycol and mixtures thereof.

Step ii) usually comprises a provision of the solution (S) in a form that corresponds to the form of the membrane (M) which is obtained in step ii).

Therefore, in one embodiment of the present invention step ii) comprises a casting of the solution (S) to obtain a film of the solution (S) or a passing of the solution (S) through at least one spinneret to obtain at least one hollow fiber of the solution (S).

Therefore, in one preferred embodiment of the present invention, step ii) comprises the following steps:
ii-1) casting the solution (S) provided in step i) to obtain a film of the solution (S),
ii-2) evaporating the at least one solvent from the film of the solution (S) obtained in step ii-1) to obtain the membrane (M) which is in the form of a film.

This means that the membrane (M) is formed by evaporating the at least one solvent from a film of the solution (S).

In step ii-1) the solution (S) can be cast by any method known to the skilled person. Usually, the solution (S) is cast with a casting knife that is heated to a temperature in the range from 20 to 150° C., preferably in the range from 40 to 100° C.

The solution (S) is usually cast on a substrate that does not react with the polyarylethersulfone-polyalkylene oxide block copolymer (PPC) or the at least one solvent comprised in the solution (S).

Suitable substrates are known to the skilled person and are, for example, selected from glass plates and polymer fabrics such as non-woven materials.

To obtain a dense membrane, the separation in step ii) is typically carried out by evaporation of the at least one solvent comprised in the solution (S).

The present invention is further elucidated by the following working examples without limiting it thereto.

### EXAMPLES

### Components Used

DCDPS: 4,4′-dichlorodiphenyl sulfone,
TMH: trimethylhydroquinone,
DHDPS: 4,4′-dihydroxydiphenyl sulfone,
Polyethyleneglycol 2000: Mₙ=2004 g/mol, determined via OH-titration
PEO-PPO-PEO 5500: Mₙ=5500 g/mol, determined via OH-titration; 50 wt.-% of PPO
Potassium carbonate: K₂CO₃; anhydrous; volume-average particle size of 32.4 μm,
NMP: N-methylpyrrolidone,
PESU: polyethersulfone (ULTRASON® E 3010)
PVP: polyvinylpyrrolidone; (Luvitec® K40)
PEG: polyethyleneglycol
DMAc: dimethylacetamide

### General Procedures

The viscosity number of the polymers is determined in a 1% solution in NMP at 25° C.

The isolation of the polymers is carried out by dripping a NMP solution of the polymers in demineralized water at room temperature (25° C.). The drop height is 0.5 m, the throughput is about 2.5 l/h. The beads obtained are then extracted with water (water throughput 160 l/h) at 85° C. for 20 h. The beads are dried at 150° C. for 24 h (hours) at reduced pressure (<100 mbar).

The number average molecular weights (Mₙ) and the weight average molecular weights (M_{w}) are determined via GPC in DMAc/LiBr with PMMA (poly(methylmethacrylate)) standards.

The incorporation rate (incorporation ratio) of PEG and other polyether units and TMH was determined by ¹H-NMR in CDCl₃/TMS. In this case the signal intensity of the aliphatic PEG units is considered in relation to the intensity of the aromatic units of the polyarylether. This gives a value for the PEG fraction in mol-% which can be converted into %-by weight with the no molecular weights of the corresponding structured units.

The contact angle between the water and the surfaces of the films prepared from CDCl₃-solution where obtained using a contact angle measuring instrument (Drop shape analysis system DSA 10 MK 2 from Krüss GmbH, Germany). The smaller the contact angle is, the higher is the hydrophilicity of the films.

### Example 1: PESU-TMH-co PEO 1

In a 4 liter glass reactor fitted with a thermometer, a gas inlet tube and a Dean-Stark-trap, 568.59 g (1.98 mol) of DCDPS, 301.33 g (1.98 mol) of TMH, 80.16 g (0.04 mol) Polyethyleneglycol 2000 and 304.06 g (2.20 mol) of potassium carbonate were suspended in 950 ml NMP in a nitrogen atmosphere.

The mixture was heated to 190° C. within one hour. In the following, the reaction time shall be understood to be the time during which the reaction mixture was maintained at 190° C. The water that was formed in the reaction was continuously removed by distillation.

After a reaction time of 7 hours, the reaction was stopped by the addition of 2050 ml NMP and cooling down to room temperature (within one hour). The potassium chloride formed in the reaction was removed by filtration. The time to filter the viscous solution in a pressure filter using N₂-pressure of 4 bar and a filter plate with 5 μm pore size was recorded. Results of the characterization are summarized in table 1.

### Example 2: PESU-TMH-co PEO

In a 4 liter glass reactor fitted with a thermometer, a gas inlet tube and a Dean-Stark-trap, 568.58 g (1.98 mol) of DCDPS, 298.26 g (1.96 mol) of TMH, 120.24 g (0.06 mol) Polyethyleneglycol 2000 and 304.06 g (2.20 mol) of potassium carbonate were suspended in 950 ml NMP in a nitrogen atmosphere.

The mixture was heated to 190° C. within one hour. In the following, the reaction time shall be understood to be the time during which the reaction mixture was maintained at 190° C. The water that was formed in the reaction was continuously removed by distillation.

After a reaction time of 7 hours, the reaction was stopped by the addition of 2050 ml NMP and cooling down to room temperature (within one hour). The potassium chloride formed in the reaction was removed by filtration. The time to filter the viscous solution in a pressure filter using N₂-pressure of 4 bar and a filter plate with 5 μm pore size was recorded. Results of the characterization are summarized in table 1.

### Example 3: PESU-TMH-co PEO

In a 4 liter glass reactor fitted with a thermometer, a gas inlet tube and a Dean-Stark-trap, 568.58 g (1.98 mol) of DCDPS, 292.16 g (1.92 mol) of TMH, 200.40 g (0.10 mol) Polyethyleneglycol 2000 and 304.06 g (2.20 mol) of potassium carbonate were suspended in 950 ml NMP in a nitrogen atmosphere.

The mixture was heated to 190° C. within one hour. In the following, the reaction time shall be understood to be the time during which the reaction mixture was maintained at 190° C. The water that was formed in the reaction was continuously removed by distillation.

After a reaction time of 7 hours, the reaction was stopped by the addition of 2050 ml NMP and cooling down to room temperature (within one hour). The potassium chloride formed in the reaction was removed by filtration. The time to filter the viscous solution in a pressure filter using N₂-pressure of 4 bar and a filter plate with 5 μm pore size was recorded. Results of the characterization are summarized in table 1.

### Example 4: PESU-TMH-co-PEO-PPO-PEO

In a 4 liter glass reactor fitted with a thermometer, a gas inlet tube and a Dean-Stark-trap, 568.58 g (1.98 mol) of DCDPS, 302.79 g (1.99 mol) of TMH, 165.00 g (0.03 mol) PEO-PPO-PEO 5500 (50 wt % PPO) and 304.06 g (2.20 mol) of potassium carbonate were suspended in 950 ml NMP in a nitrogen atmosphere.

The mixture was heated to 190° C. within one hour. In the following, the reaction time shall be understood to be the time during which the reaction mixture was maintained at 190° C. The water that was formed in the reaction was continuously removed by distillation.

After a reaction time of 8 hours, the reaction was stopped by the addition of 2050 ml NMP and cooling down to room temperature (within one hour). The potassium chloride formed in the reaction was removed by filtration. The time to filter the viscous solution in a pressure filter using N₂-pressure of 4 bar and a filter plate with 5 μm pore size was recorded. Results of the characterization are summarized in table 1.

### Comparative Example 5: PESU-co-PEO

In a 4 liter glass reactor fitted with a thermometer, a gas inlet tube and a Dean-Stark-trap, 574.32 g (2.00 mol) of DCDPS, 490.55 g (1.96 mol) of DHDPS, 80.16 g (0.04 mol) Polyethyleneglycol 2000 and 304.06 g (2.20 mol) of potassium carbonate were suspended in 950 ml NMP in a nitrogen atmosphere.

The mixture was heated to 190° C. within one hour. In the following, the reaction time shall be understood to be the time during which the reaction mixture was maintained at 190° C. The water that was formed in the reaction was continuously removed by distillation.

After a reaction time of 7 hours, the reaction was stopped by the addition of 2050 ml NMP and cooling down to room temperature (within one hour). The potassium chloride formed in the reaction was removed by filtration. The time to filter the viscous solution in a pressure filter using N₂-pressure of 4 bar and a filter plate with 5 μm pore size was recorded. Results of the characterization are summarized in table 1.

### Comparative Example 6: PESU-co-PEO

In a 4 liter glass reactor fitted with a thermometer, a gas inlet tube and a Dean-Stark-trap, 574.32 g (2.00 mol) of DCDPS, 485.54 g (1.94 mol) of DHDPS, 120.24 g (0.06 mol) Polyethyleneglycol 2000 and 304.06 g (2.20 mol) of potassium carbonate were suspended in 950 ml NMP in a nitrogen atmosphere.

The mixture was heated to 190° C. within one hour. In the following, the reaction time shall be understood to be the time during which the reaction mixture was maintained at 190° C. The water that was formed in the reaction was continuously removed by distillation.

After a reaction time of 7 hours, the reaction was stopped by the addition of 2050 ml NMP and cooling down to room temperature (within one hour). The potassium chloride formed in the reaction was removed by filtration. The time to filter the viscous solution in a pressure filter using N₂-pressure of 4 bar and a filter plate with 5 μm pore size was recorded. Results of the characterization are summarized in table 1.

### Comparative Example 7: PESU-co-PEO

In a 4 liter glass reactor fitted with a thermometer, a gas inlet tube and a Dean-Stark-trap, 574.32 g (2.00 mol) of DCDPS, 475.53 g (1.90 mol) of DHDPS, 200.40 g (0.10 mol) Polyethyleneglycol 2000 and 304.06 g (2.20 mol) of potassium carbonate were suspended in 950 ml NMP in a nitrogen atmosphere.

The mixture was heated to 190° C. within one hour. In the following, the reaction time shall be understood to be the time during which the reaction mixture was maintained at 190° C. The water that was formed in the reaction was continuously removed by distillation.

After a reaction time of 7 hours, the reaction was stopped by the addition of 2050 ml NMP and cooling down to room temperature (within one hour). The potassium chloride formed in the reaction was removed by filtration. The time to filter the viscous solution in a pressure filter using N₂-pressure of 4 bar and a filter plate with 5 μm pore size was recorded. Results of the characterization are summarized in table 1.

### Comparative Example 8: PSU-Co-PEO

In a 4 liter glass reactor fitted with a thermometer, a gas inlet tube and a Dean-Stark-trap, 574.32 g (2.00 mol) of DCDPS, 447.44 (1.96 mol) Bisphenol A, 80.16 g (0.04 mol) of Polyethyleneglycol 2000 and 304.06 g (2.20 mol) of potassium carbonate were suspended in 950 ml NMP in a nitrogen atmosphere.

The mixture was heated to 190° C. within one hour. In the following, the reaction time shall be understood to be the time during which the reaction mixture was maintained at 190° C. The water that was formed in the reaction was continuously removed by distillation. After a reaction time of 10 hours, the reaction was stopped by the addition of 2050 ml NMP and cooling down to room temperature (within one hour). The potassium chloride formed in the reaction was removed by filtration. The time to filter the viscous solution in a pressure filter using N₂-pressure of 4 bar and a filter plate with 5 μm pore size was recorded for the different batches.

TABLE 1

| | Example | | | | | | | |
|---|---|---|---|---|---|---|---|---|
| | | | | | Comp. | Comp. | Comp. | Comp. |
| | Ex. 1 | Ex. 2 | Ex.3 | Ex. 4 | Ex 5 | Ex. 6 | Ex. 7 | Ex. 8 |
| | Product | | | | | | | |
| | | | | PESU-TMH- | | | | |
| | PESU-TMH- | PESU-TMH- | PESU-TMH- | co-PEO- | PESU- | PESU- | PESU- | PSU- |
| | co-PEO | co-PEO | co-PEO | PPO-PEO | co-PEO | co-PEO | co-PEO | co-PEO |
| V.N. [ml/g] | 64.9 | 62.9 | 59.9 | 64.8 | 65.2 | 73.5 | 74.1 | 63.8 |
| content | 8.8 | 14.0 | 21.1 | 17.2 | 7.9 | 11.4 | 17.9 | 8.1 |
| PEO/PPO | | | | | | | | |
| [wt. %] | | | | | | | | |
| Tg [° C.] | 189 | 176 | 153 | −65/191 | 178 | 157 | 131 | 141 |
| Contact | 54 | 48 | 40 | 36 | 61 | 57 | 53 | n.b. |
| Angle [°] | | | | | | | | |
| Filtration | 7 | 7.2 | 8.5 | 9 | 12.5 | 16.0 | 21.5 | 19 |
| time [h] | | | | | | | | |

Surprisingly, the solutions of the inventive polyarylethersulfone-polyalkylene oxide block copolymer (PPC) can be filtered much better than the ones of the comparative PESU-co-PEO products. At a given PEO-content, the inventive copolymers have much higher hydrophilicity, as can be seen from the contact angles.

### Preparation of Membranes:

Membranes were prepared by adding 78 ml of NMP, 5 g of PVP and 17 g of polymer into a three neck flask equipped with a magnetic stirrer. This mixture is then heated under gentle stirring at 60° C. until a homogeneous clear viscous solution is obtained. The solution is degassed over night at room temperature. After that, the solution is re-heated at 60° C. for 2 h and casted onto a glass plate with a casting knife (300 microns) at 60° C. at a speed of 5 mm/min. The obtained film is then rest for 30 sec and subsequently immersed into a water bath at 25° C. for 10 min. After the membrane is detached from the glass plate, the membrane is carefully transferred into a water bath for 12 h. Afterwards, the membrane is transferred into a bath containing 250 ppm NaOCl at 50° C. for 4.5 h. The membrane is washed with water at 60° C. and a 0.5 weight-% solution of Na-bisulfit to remove active chlorine. A membrane having a dimension of at least 10×15 cm size is obtained.

To test the pure water permeation (PWP) of the membranes, ultrapure water (salt-free water filtered by a Millipore UF-system) using a pressure cell with a diameter of 60 mm, is used. In a subsequent test a solution of different PEG standards is filtered at a pressure of 0.15 bar. By GPC-measurements of the feed and the permeate, the molecular weight cut-off (MWCO) is determined.

The gel fraction of the membranes was determined by dissolving 0.5 g of dry membrane material in 50 ml of NMP (24 h, room temperature, stirring). This solution was then filtered through a pre-weighed (m₀) filter paper. The filter paper was tried in the vacuum for 24 h at 100° C. cooled to room temperature and weighed again (m_{g}). The gel-content was calculated as:

Gel-Fraction=(m_{g}−m₀)/m₀*100

### Reference Polymer for the Membrane Trials

### Comparative Example 8: PESU-TMH

In a 4 liter glass reactor fitted with a thermometer, a gas inlet tube and a Dean-Stark-trap, 574.34 g (2.00 mol) of DCDPS, 304.38 g (2.00 mol) of TMH and 290.24 g (2.10 mol) of potassium carbonate were suspended in 950 ml NMP in a nitrogen atmosphere.

The mixture was heated to 190° C. within one hour. In the following, the reaction time shall be understood to be the time during which the reaction mixture was maintained at 190° C. The water that was formed in the reaction was continuously removed by distillation.

After a reaction time of eight hours, the reaction was stopped by the addition of 2050 ml NMP and cooling down to room temperature (within one hour). The potassium chloride formed in the reaction was removed by filtration. The viscosity number was 65.8 ml/g.

Furthermore, neat PESU having a viscosity number of 66 ml/g was used.

The results are shown in table 2.

TABLE 2

| | Comp. | Comp. | | Comp. | |
|---|---|---|---|---|---|
| | M1 | M2 | M3 | M4 | M5 |
| PESU [g] | 17 | | | | |
| Comp. | | 17 | | | |
| Ex. 8 (PESU-TMH) [g] | | | | | |
| Ex. 1 (PESU-TMH-co-PEO) | | | 17 | | |
| [g] | | | | | |
| Comp. | | | | 17 | |
| Ex. 6 (PESU-PEO) [g] | | | | | |
| Ex. 3 (PESU-TMH-co-PEO) | | | | | 17 |
| [g] | | | | | |
| PVP [g] | 5 | 5 | 5 | 5 | 5 |
| NMP [g] | 78 | 78 | 78 | 78 | 78 |
| PWP [l/m²*h*bar] | 630 | 330 | 690 | 870 | 950 |
| MWCO [kD] | 73 | 16 | 23 | 89 | 23 |
| Gel-Fraction [wt %] | 0 | 9 | 10 | 0 | 9 |

The membranes prepared from the new copolymers show excellent filtration performance. Surprisingly, the membranes are not completely soluble in NMP, indicating improved solvent resistance, which will be useful to filter produced water, containing organic contaminants.

1: A process for preparing a polyarylethersulfone-polyalkylene oxide block copolymer (PPC), the process comprising:
I) converting a reaction mixture (R₀) comprising:
(A1) at least one aromatic dihalogen sulfone,
(B1) at least one aromatic dihydroxy component comprising trimethylhydroquinone,
(B2) at least one polyalkylene oxide,
(C) at least one carbonate component, and
(D) at least one aprotic polar solvent,
to obtain the polyarylethersulfone-polyalkylene oxide block copolymer.

2: The process according to claim 1, wherein component (A selected from the group consisting of 4,4′-dichlorodiphenyl sulfone and 4,4′-difluorodiphenyl sulfone.

3: The process according to claim 1, wherein component (B1) comprises at least 50 mol-% of trimethylhydroquinone, based on a total amount of component (B1).

4: The process according to claim 1, wherein component (B2) comprises at least 50% by weight of a polyalkylene oxide obtained by polymerizing ethylene oxide, 1,2-propylene oxide, 1,2-butylene oxide, 2,3-butylene oxide, 1,2-pentene oxide, 2,3-pentene oxide, tetrahydrofuran, or mixtures of two or more of these monomers, based on a total weight of component (B2).

5: The process according to claim 1, wherein component (C) comprises at least 50% by weight of potassium carbonate, based on a total weight of component (C).

6: The process according to claim 1, wherein component (D) is selected from the group consisting of N-methylpyrrolidone, N-dimethylacetamide, dimethylsulfoxide and dimethylformamide.

7: A polyarylethersulfone-polyalkylene oxide block copolymer (PPC) obtained by the process of claim 1 6.

8: A membrane (M), comprising a polyarylethersulfone-polyalkylene oxide block copolymer (PPC) according to claim 7.

9: The membrane (M) according to claim 8, wherein the membrane (M) is asymmetric.

10: The membrane (M) according to claim 8, wherein the membrane (M) is a porous membrane or a dense membrane.

11: A process, comprising forming a membrane (M) from the polyarylethersulfone-polyalkylene oxide block copolymer (PPC) according to claim 7.

12: A method for preparing the membrane (M) of claim 8, the method comprising:
i) forming providing a solution (S) comprising the polyarylethersulfone-polyalkylene oxide block copolymer (PPC) and at least one solvent, and
ii) separating the at least one solvent from the solution (S) to obtain the membrane (M).

13: The method according to claim 12, wherein the at least one solvent is selected from the group consisting of N-methylpyrrolidone, dimethylacetamide, dimethyl sulfoxide, dimethylformamide, dimethyllactamid and sulfolane.

14: The method according to claim 12, wherein the solution (S) comprises from 0.1 to 30% by weight of the polyarylethersulfone-polyalkylene oxide block copolymer (PPC), based on a total weight of the solution (S).

15: The method according to claim 12, wherein the separating ii) is performed by a phase inversion process.
